(19) United States
(12) Patent Application Publication
(10) Pub. No.: US 2005/0234205 A1
(43) Pub. Date: Oct. 20, 2005

(54) Copolymer, paper-treating agent, and processed paper

(76) Inventors: Fumihiko Yamaguchi, Osaka (JP); Masahiko Ishikawa, Settsu-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/516,544

(22) PCT Filed: Jun. 12, 2003
(86) PCT No.: PCT/JP03/07464

§ 371 Date: Dec. 2, 2004

(30) Foreign Application Priority Data
Jun. 13, 2002 (JP) 200-173040

(51) Int. Cl. C08F 12/20

(52) U.S. Cl. 526/242; 526/319; 526/310; 526/264

(57) ABSTRACT

A paper treatment agent which contains a copolymer essentially comprising a repeating unit derived from a polyfluoroalkyl group-containing (meth)acrylate, a repeating unit derived from a pyrrolidone monomer, a nitrogen-containing repeating unit such as —[CH₂C(CH₃)[COOCH₂CH₂CH₂N⁺(CH₃)₃.Cl]]—, and an anionic functional group-containing repeating unit such as —[CH₂C(CH₃)COOH]— has a relatively low viscosity, and the action of the treatment agent hardly lowers even when a cationic paper strength-enhancing agent is used in combination therewith.

### FIELD OF THE INVENTION

The present invention relates to novel copolymers, paper treatment agents comprising the copolymers, and paper treated with the paper treatment agents.

### RELATED ART

Hitherto the following water- and oil-resistance processing agents for paper have been proposed:

(1) A processing agent which comprises a phosphate ester compound having a polyfluoroalkyl group (hereinafter referred as a R_{f} group) as an essential component (cf. JP-A-64-6196 and JP-A-3-123786).

(2) A processing agent which comprises a copolymer of an acrylate having a R_{f} group and vinylidene chloride, as an essential component (cf. JP-A-55-69677, JP-A-51-133511 and JP-B-53-22547).

(3) A processing agent which comprises a copolymer of an acrylate having a R_{f} group, dimethylaminoalkyl methacrylate and vinyl acetate, as an essential component (cf. JP-A-7-206942).

The phosphate ester compound having a R_{f} group, contained in the processing agent (1), is a water-soluble compound, and therefore can not impart water repellency to paper, and further markedly lowers oil repellency, if a sizing agent is contained in the processing agent.

To generally proof paper against oil, external addition processing methods which impregnate or coat a base paper with a processing agent are employed. In the external addition processing methods, a size press and various coaters are used, and the treated paper is dried at a temperature of 80 to 100° C. for such short time as several seconds to several tens seconds. When the processing agent is used in the external addition processing method, it is necessary to select such a processing agent that can impart high water- and oil-resistance properties to paper at a relatively low temperature for relatively short time.

When the processing agent (2) is diluted with water for external addition to paper and the immersion, drawing or circulation is carried out at a high speed, the following problems arise: the stability of the processing agent becomes poor; scum occurs in the processing agent; dirt deposits on the rolls; the adsorption of the processing agent onto the paper becomes insufficient, and so on. Thus, sufficient properties can not be imparted to the paper.

The processing agent (3) can not impart sufficient performance to paper when used in combination with a cationic agent such as a paper strength agent or sizing agent.

### SUMMARY OF THE INVENTION

The present inventors have discovered that sufficient performance can be imparted to paper by treating the paper with a paper treatment agent which comprises, as an essential component, a copolymer having specified repeating units, even if the agent is used in combination with a cationic agent (e.g., a paper strength agent), and that this paper treatment agent has a low viscosity and thus is easily handled.

The subject matter of the present invention relates to a fluorine-containing copolymer comprising:
(a) 50 to 92% by weight of at least one fluoromonomer of the general formula: 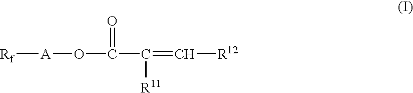
   wherein R_{f} represents a linear or branched fluoroalkyl group having 1 to 21 carbon atoms, preferably 4 to 16 carbon atoms,
A represents a divalent organic group having a carbon atom to be bonded to an oxygen atom adjacent to the group A, and if needed, at least one oxygen atom, sulfur atom and/or nitrogen atom, and
one of R¹¹ and R¹² represents a hydrogen atom, and the other thereof represents a hydrogen atom or an alkyl group having 1 to 4 carbon atoms,
(b) 1 to 25% by weight of at least one nitrogen-containing monomer of the general formula: 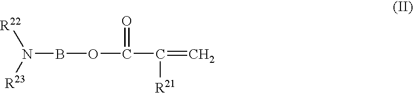
   and/or the formula: 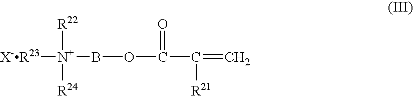
   wherein B represents a linear or branched alkylene group having 1 to 4 carbon atoms; R²¹ represents a hydrogen atom or an alkyl group having 1 to 4 carbon atoms; R²², R²³ and R²⁴ are the same or different, each representing a hydrogen atom, a linear or branched alkyl group having 1 to 18 carbon atoms, or a hydroxyethyl group or a benzyl group, or otherwise, R²² and R²³ together form a divalent organic group having 2 to 30 carbon atoms; and
X⁻ represents an anionic group,
   (c) 1 to 25% by weight of a pyrrolidone monomer of the general formula: 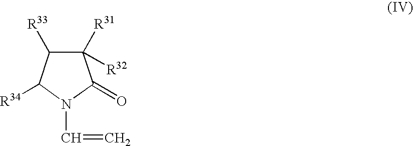
      wherein R³¹, R³², R³³ and R³⁴ are the same or different, each representing a hydrogen atom or an alkyl group having 1 to 4 carbon atoms, and
(d) 1 to 5% by weight of a monomer having an anionic functional group.

### DETAILED DESCRIPTION OF THE INVENTION

The copolymer of the present invention may further comprise 0 to 10% by weight of at least one monomer (e) other than the monomers (a), (b), (c) and (d). The copolymer of the present invention has constituting units derived from the monomers (a), (b), (c) and (d), and if needed, the monomer (e).

Throughout the present specification, an acrylate and a methacrylate are generally referred to as (meth)acrylate. Likewise, (meth)acrylamide and the like are used as generic terms as above.

The R_{f} group is a group in which at least two hydrogen atoms of a C₁-C₂₁ alkyl group are substituted with fluorine atoms. The R_{f} group may have a linear or branched chain structure, and preferably has 2 to 20 carbon atoms, particularly 4 to 16 carbon atoms. The ratio of fluorine atoms in the R_{f} group is preferably at least 60%, more preferably at least 80%, in particular, substantially 100%, when expressed by the equation: (the number of fluorine atoms in the R_{f} group)/(the number of hydrogen atoms in an alkyl group which has the same number of carbon atoms as that of the R_{f} group)×100 (%). Particularly preferred R_{f} group is a perfluoroalkyl group which is formed by substituting all the hydrogen atoms in the alkyl group with fluorine atoms.

The fluoromonomer (a) is a (meth)acrylate having a R_{f} group, which is a compound having the R_{f} group in the ester residue of (meth)acrylate. One or at least two different (meth)acrylates having R_{f} groups may be used.

For example, the fluoromonomer (a) may be a fluoroalkyl group-containing (meth)acrylate of the general formula:
R_{f}-A-OCOCR¹¹═CH₂ (I-a)
wherein R_{f}, R¹¹ and A are as defined in the formula (I).

In the formula (I) or (I-a), the A group may be a linear or branched alkylene group having 1 to 20 carbon atoms, a group of the formula: —SO₂N(R²¹)R²²— or a group of the formula: —CH₂CH(OR²³)CH₂— (in which R²¹ represents an alkyl group having 1 to 10 carbon atoms; R²² represents a linear or branched alkylene group having 1 to 10 carbon atoms; and R²³ represents a hydrogen atom or an acyl group having 1 to 10 carbon atoms).

Examples of the fluoromonomer (a) include the followings: 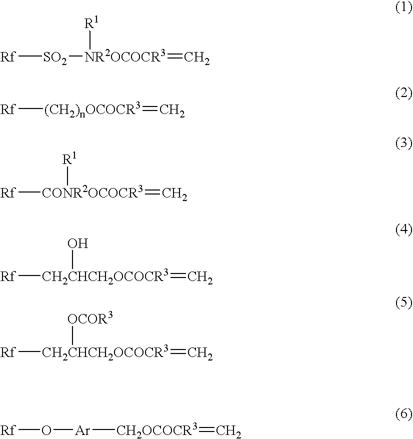
wherein R_{f} represents a fluoroalkyl group having 1 to 21 carbon atoms; R¹ represents a hydrogen atom or an alkyl group having 1 to 10 carbon atoms; R² represents an alkylene group having 1 to 10 carbon atoms; R³ represents a hydrogen atom or a methyl group; Ar represents an optionally substituted arylene group; and n is an integer of 1 to 10.

Specific examples of the fluoromonomer (a) include the following compounds, in each of which R⁶ represents a hydrogen atom or a methyl group:
CH₂═CR⁶COOCH₂CH₂R_{f},
CH₂═CR⁶COOCH₂CH₂N(CH₂CH₂CH₃)COR_{f},
CH₂═CR⁶COOCH(CH₃)CH₂R_{f},
CH₂═CR⁶COOCH₂CH₂N(CH₃)SO₂R_{f},
CH₂═CR⁶COOCH₂COOCH₂N(CH₃)COR_{f},
CH₂═CR⁶COOCH₂CH₂N(CH₂CH₃)SO₂R_{f},
CH₂═CR⁶COOCH₂CH₂N(CH₂CH₃)COR_{f},
CH₂═CR⁶COOCH₂CH₂N(CH₂CH₂CH₃)SO₂R_{f}, and
CH₂═CR⁶COOCH(CH₂Cl)CH₂OCH₂CH₂N(CH₃)SO₂R_{f}.

More specific examples of the fluoromonomer (a) include the following compounds:
F(CF₂)₅CH₂OCOCR⁶═CH₂,
F(CF₂)₆CH₂CH₂OCOCR═CH₂,
H(CF₂)₆CH₂OCOCR⁶═CH₂,
H(CF₂)₈CH₂OCOCR⁶═CH₂,
H(CF₂)₁₀CH₂OCOCR⁶═CH₂,
H(CF₂)₈CH₂CH₂OCOCR⁶═CH₂,
F(CF₂)₈CH₂CH₂CH₂OCOCR═CH₂,
F(CF₂)₁₀CH₂CH₂OCOCR⁶═CH₂,
F(CF₂)₁₀CH₂CH₂OCOCR⁶═CH₂,
(CF₃)₁₂ CF(CF₂)₄CH₂CH₂OCOCR⁶═CH₂,
(CF₃)₂CF(CF₂)₆CH₂CH₂OCOCR⁶═CH₂,
(CF₃)₂CF(CF₂)₈CH₂CH₂OCOCR⁶═CH₂,
F(CF₂)₂SO₂N(C₃H₇)CH₂CH₂OCOCR⁶═CH₂,
F(CF₂)₈CON(C₃H₇)CH₂CH₂OCOCR═CH₂,
F(CF₂)₈CH₂CH(CH₃)OCOCR⁶═CH₂,
F(CF₂)₈(CH₂)₄OCOCR═CH₂,
F(CF₂)₈SO₂N(CH₃)CH₂CH₂OCOCR⁶═CH₂,
F(CF₂)₈CON(CH₃)CH₂CH₂OCOCR⁶═CH₂,
F(CF₂)₈SO₂N(C₂H₅)CH₂CH₂OCOCR⁶═CH₂,
F(CF₂)₈CON(C₂H₅)CH₂CH₂OCOCR⁶═CH₂,
F(CF₂)₈CONHCH₂CH₂OCOCR⁶═CH₂,
(CF₃)₂CF(CF₂)₅(CH₂)₃OCOCR⁶═CH₂,
(CF₃)₂CF(CF₂)₅CH₂CH(OCOCH₃)₃OCOCR⁶═CH₂,
(CF₃)₂CF(CF₂)₅CH₂CH(OH)CH₂OCOCR⁶═CH₂,
(CF₃)₂CF(CF₂)₇CH₂CH(OH)CH₂OCOCR⁶═CH₂,
F(CF₂)₉CH₂CH₂OCOCR⁶═CH₂,
F(CF₂)₉CONHCH₂CH₂OCOCR⁶═CH₂, and
F(CF₂)₉SO₂N(CH₃)CH₂CH₂CH₂CH(CH₂Cl)OCOCR⁶═CH₂.
   wherein R⁶ represents a hydrogen atom or a methyl group.

The nitrogen-containing monomer (b) is a compound having at least one nitrogen atom (particularly an amino group) and one carbon-carbon double bond. The nitrogen-containing monomer (b) is a compound of the formula (II) in which the nitrogen atom is not cationic, or a compound of the formula (III) in which the nitrogen atom is cationic. The nitrogen-containing monomer (b) of the formula (II) is a (meth)acrylate having no cationic group. The nitrogen-containing monomer of the formula (III) is a (meth)acrylate having a cationic group.

The groups R²² and R²³ in the formula (II) are each independently an alkyl group, or the groups R²² and R²³ together may form a divalent organic group. The alkyl group is preferably a methyl group or an ethyl group.

A quaternary ammonium salt group may be present as the cationic group in the monomer (b). In other words, R²²R²³ and R²⁴ in the formula (III) are each independently an alkyl group; or otherwise, R²² and R²³ together may form a divalent organic group, and R²⁴ may be an alkyl group. The alkyl group is preferably a methyl group or an ethyl group.

The divalent organic group which is formed by R²² and R²³ in the formula (II) or (III) is preferably a polymethylene group having at least 2 carbon atoms, a group formed by substituting at least one hydrogen atom of said polymethylene group, or a group formed by inserting an ether-like oxygen atom into the carbon-carbon bond of the polymethylene group. The substituent for the hydrogen atom of the polymethylene group is preferably an alkyl group such as a methyl group, ethyl group or n-propyl group. The groups R²² and R²³ may form a morpholino group, piperidino group or 1-pyrrolidinyl group, together with the nitrogen atom bonded to both of them.

The group X⁻ is a counter ion (an anionic group). The group X is a halogen atom or a residue remaining after one cationic hydrogen atom is allowed to leave from an acid (an inorganic acid or an organic acid). Example of the group X⁻ include a chlorine ion (Cl⁻), bromine ion (Br⁻), iodine ion (I⁻), hydrogensulfate ion (HSO₄⁻) and acetic acid ion (CH₃COO⁻).

Examples of the nitrogen-containing monomer (b) include dimethylaminoethyl methacrylate, dimethylaminopropyl methacrylate, diethylaminoethyl methacrylate, diethylaminopropyl methacrylate, N-tert.-butylaminoethyl methacrylate, dimethylaminoethyl acrylate, dimethylaminopropyl acrylate, diethylaminoethyl acrylate, diethylaminopropyl acrylate, and N-tert-butylaminoethyl acrylate.

One or at least two repeating units derived from the nitrogen-containing monomer (b) may be contained in the copolymer. When the copolymer comprises at least two repeating units, the repeating units preferably contain alkyl moieties or counter ions which are different. The presence of the nitrogen-containing monomer (b) can give paper treated with the processing agent the high resistance to water and oil after dried at a relatively low temperature for relatively short time, and also, can improve the stability of the processing agent itself.

Examples of the repeating unit having no cationic group, derived from the nitrogen-containing monomer (b), include the followings:
—[CH₂—C(R)[COO(CH₂)₂N(CH₃)₂]]—,
—[CH₂—C(R)[COO(CH₂)₃N(CH₃)₂)]]—,
—[CH₂—C(R)[COO(CH₂)₂N(CH₂CH₃)₂]]—,
—[CH₂—C(R)[COO(CH₂)₃N(CH₂CH₃)₂]]—,
—[CH₂—C(R)[COOCH₂CH(OH)CH₂N(CH₃)₂]]—,
—[CH₂—C(R)[COOCH₂CH(OH)CH₂N(CH₂CH₃)₂]]—,
—[CH₂—C(R)[CONH(CH₂)₂N(CH₃)₂]]—,
—[CH₂—C(R)[CONH(CH₂)₃N(CH₃)₂]]—,
—[CH₂—C(R)[CONH(CH₂)₂N(CH₂CH₃)₂]]—, and
—[CH₂—C(R)[CONH(CH₂)₃N(CH₂CH₃)₂]]—.

Examples of the repeating unit having a cationic group, derived from the nitrogen-containing monomer (b), include the followings:
—[CH₂—C(R)[COO(CH₂)₂N⁺(CH₃)₃.X⁻]]—,
—[CH₂—C(R)[COO(CH₂)₃N⁺(CH₃)₃.X⁻]]—,
—[CH₂—C(R)[COO(CH₂)₂N⁺(CH₂CH₃)₃.X⁻]]—,
—[CH₂—C(R)[COO(CH₂)₃N⁺(CH₂CH₃)₃.X⁻]]—,
[CH₂—C(R)[COOCH₂CH(OH)CH₂N⁺(CH₃)₃.X⁻]]—,
—[CH₂—C(R)[COOCH₂CH(OH)CH₂N⁺(CH₂CH₃)₃.X⁻]]—,
—[CH₂—C(R)[CONH(CH₂)₂N⁺(CH₃)₃.X⁻]]—,
[CH₂—C(R)[CONH(CH₂)₃N⁺(CH₃)₃.X⁻]]—,
[CH₂—C(R)[CONH(CH₂)₂N⁺(CH₂CH₃)₃.X⁻]]—,
—[CH₂—C(R)[CONH(CH₂)₃N⁺(CH₂CH₃)₃.X⁻]]—,
—[CH₂—C(R)[COO(CH₂)₂N⁺H(CH₃)₂.X⁻]]
[CH₂—C(R)[COO(CH₂)₃N⁺H(CH₃)₂.X⁻]]—,
[CH₂—C(R)[COO(CH₂)₂N⁺H(CH₂CH₃)₂.X⁻]]—,
—[CH₂—C(R)[CONH(CH₂)₂N⁺H(CH₃)₂.X⁻]]—,
—[CH₂—C(R)[CONH(CH₂)₃N⁺H(CH₃)₂.X⁻]]—,
—[CH₂—C(R)[CONH(CH₂)₂N⁺H(CH₂CH₃)₂.X⁻]]—, and
—[CH₂—C(R) [CONH(CH₂)₃N⁺H(CH₂CH₃)₂.X⁻]]—.

The pyrrolidone monomer (c) is a compound which has a pyrrolidone group and one carbon-carbon double bond. In the formula (IV), R³¹R³², R³³ and R³⁴ are each preferably a hydrogen atom or a methyl group. Examples of the pyrrolidone monomer (c) include N-vinyl-2-pyrrolidone, N-vinyl-3-methyl-2-pyrrolidone, N-vinyl-4-methyl-2-pyrrolidone, N-vinyl-5-methyl-2-pyrrolidone and N-vinyl-3,3-dimethyl-2-pyrrolidone.

The monomer (d) having an anionic functional group is a compound having an anionic functional group and one carbon-carbon double bond. Examples of the anionic functional group include —C(═O)OH, —SO₃H, and —SO₃Na. Examples of the monomer (d) include an acrylic acid, methacrylic acid, sodium styrene sulfonate, itaconic acid and fumaric acid.

The copolymer of the present invention may comprise other monomer (e) in addition to the monomers (a), (b), (c) and (d). Examples of the other monomer (e) include the followings: ethylene, vinyl acetate, vinyl chloride, vinyl fluoride, vinylstyrene halide, α-methylstyrene, p-methylstyrene, polyoxyalkylene mono(meth)acrylate, (meth)acrylamide, diacetone (meth)acrylamide, methylol(meth)acrylamide, N-methylol(meth)acrylamide, alkyl vinyl ether, alkyl vinyl ether halide, alkyl vinyl ketone, butadiene, isoprene, chloroprene, glycidyl(meth)acrylate, 2-hydroxyethyl(meth)acrylate, aziridinyl(meth)acrylate, benzyl(meth)acrylate, isocyanate ethyl(meth)acrylate, cyclohexyl(meth)acrylate, short chain alkyl(meth)acrylate, maleic anhydride, (meth)acrylate having a polydimethylsiloxane group, and N-vinylcarbazole.

The amounts of the monomers may be as follows, based on the weight of the copolymer:
50 to 92% by weight, for example, 75 to 90% by weight, of the monomer (a),
1 to 25% by weight, for example, 10 to 16% by weight, of the monomer (b),
1 to 25% by weight, for example, 1 to 5% by weight, of the monomer (c),
1 to 5% by weight, for example, 1 to 3% by weight, of the monomer (d), and
0 to 10% by weight, for example, 0 to 3% by weight, of the monomer (e).

The copolymer of the present invention can be prepared by polymerizing the monomers (a), (b), (c) and (d), and if needed, the monomer (e), in a liquid medium. The liquid medium is preferably a water-soluble organic solvent, or may be a mixture containing a water-soluble organic solvent. The monomers and the liquid medium are preferably in the form of a solution of the monomers dissolved in the liquid medium. Preferably, the polymerization of the monomers is carried out in the manner of solution polymerization.

According to the present invention, the repeating unit derived from the monomer (b) may be neutralized by adding an aqueous solution of an inorganic or organic acid after the completion of the copolymerization; or the copolymerization may be carried out by using the nitrogen-containing monomer (a) which has been previously neutralized with an organic acid. When the monomers are polymerized after the nitrogen-containing monomer of the formula (II) has been beforehand neutralized with an acid, the neutralization with an aqueous solution of an organic acid is not needed.

If needed, the polymer mixture resulting from the copolymerization may be admixed with a liquid medium (such as water or an aqueous solution of an inorganic or organic acid) to dilute the mixture.

Examples of the water-soluble organic solvent, i.e., the liquid medium for use in the copolymerization, include, but not limited to, ketones (e.g., acetone and methyl ethyl ketone), alcohols (e.g., methanol, ethanol and isopropanol), ethers (e.g., methyl or ethyl ether of ethylene glycol or propylene glycol and acetate ester thereof, tetrahydrofuran, and dioxane), acetonitrile, dimethylformamide, N-methyl-2-pyrrolidone, butyrolactone, and dimethyl sulfoxide. Among those, N-methyl-2-pyrrolidone (NMP) or a mixture of N-methyl-2-pyrrolidone and acetone is preferably used as the solvent. The concentration of all the monomers in the solution may be 20 to 70% by weight, preferably 40 to 60% by weight.

The copolymerization may be conducted by using 0.1 to 2.0%, based on the weight of all the monomers, of at least one initiator. As the initiator, there may be used a peroxide such as benzoyl peroxide, lauroyl peroxide, succinyl peroxide or tert-butyl perpivalate; or an azo compound such as 2,2-azobisisobutylonitrile, 4,4-azobis(4-cyanopentanoic acid) or azodicarbonamide.

The copolymerization can be carried out at a temperature between 40° C. and the boiling point of the reaction mixture.

In the diluting step, a liquid medium such as water or an aqueous solution of an inorganic or organic acid having a high or medium acidity is added to the organic solvent solution of the copolymer. Examples of such an acid include hydrochloric acid, hydrobromic acid, sulfuric acid, nitric acid, phosphoric acid, acetic acid, formic acid, propionic acid and lactic acid, among which acetic acid is preferably used. It is preferable to use a sufficient amount of the aqueous solution and a sufficient concentration of the acid in the aqueous solution, enough to completely neutralize the amine functional group of the monomer of the formula (II), and to allow the final copolymer liquid to have a solid content of 5 to 30% by weight, preferably 20 to 30% by weight.

To completely convert the amine functional group the a salt, the amount of the acid is advantageously 1 to 5 acid equivalent, preferably 2 to 3 acid equivalent, based on the nitrogen-containing monomer (b).

Hydrogen peroxide (for example, an aqueous solution of hydrogen peroxide) may be added after the completion of the copolymerization. The amount of hydrogen peroxide to be used is 0.1 to 10% by weight, preferably 0.3 to 3% by weight, based on the total weight of the monomers. The treatment by reacting hydrogen peroxide is carried out at a temperature of 25 to 100° C., preferably 70 to 85°.

A treatment agent comprising the copolymer as an active ingredient can be used to treat a substrate, particularly paper.

Paper to be treated is paper produced by a known papermaking method. The treatment agent may be internally added to pulp slurry before the papermaking (an internal addition process), or may be externally applied to paper produced by the papermaking (an external addition process).

When the paper treatment agent is applied to the surface of paper, it is preferable to use the paper treatment agent in such an amount that the ratio of fluorine atoms in the treatment agent can be 0.02 to 5% by weight, particularly 0.05 to 0.2% by weight based on the weight of the paper. When the paper treatment agent is applied to a whole of paper including the internal part thereof, it is preferable to use the paper treatment agent in such an amount that the ratio of fluorine atoms in the treatment agent can be 0.05 to 1.0% by weight, particularly 0.2 to 0.4% by weight based on the weight of pulp.

The substrate thus treated is simply dried at a room temperature or a high temperature, and then, is optionally treated by heating at a temperature of at most 200° C., depending on the nature of the substrate. The substrate treated as above shows high lipophobic and hydrophobic properties.

Substrates to be treated in the present invention include base paper for gypsum board, coating base paper, medium grade paper, ordinary liner and core, pure white neutral roll paper, neutral liner, rust-preventive liner, metal composite paper and kraft paper. Examples of the substrate also include neutral printing or writing paper, neutral coating base paper, neutral PPC paper, neutral thermosensible paper, neutral pressure-sensitive paper, neutral ink jet paper, and neutral communication paper. Further, molded paper shaped by using a mold, particularly a molded container are included in the examples of the substrate. A pulp-molded container can be made by the method described in, for example, JP-A-9-183429.

As a pulp raw material for use in forming paper, there may be used any of bleached pulp or non-bleached chemical pulp such as kraft pulp or sulfite pulp, bleached or non-bleached high yield pulp such as chip pulp, mechanical pulp or thermomechanical pulp, and waste paper pulp of news paper, journals, corrugated board and ink-removed paper. Also, a mixture of the above pulp raw material with synthetic fibers such as asbestos, polyamide, polyimide, polyester, polyolefin or polyvinyl alcohol may be used.

The water resistance of paper can be improved by adding a sizing agent to the paper. Examples of the sizing agent are a cationic sizing agent, anionic sizing agent, and rosin-based sizing agent (e.g., acidic rosin-based sizing agent, or neutral rosin-based sizing agent). A styrene-acrylic acid copolymer and an alkylketene dimer are preferred. The amount of the sizing agent may be 0.01 to 5% by weight based on the weight of the pulp.

If needed, the paper may contain additives conventionally used in papermaking, for example, a paper strength-enhancing agent such as starch, modified starch, carboxylmethyl cellulose or polyamide-polyamine-epichlorohydrin resin, a yield-improving agent, a dye, a fluorescent dye, a slime-controlling agent, and a defoaming agent.

If needed, a size press, gate roll coater, bill blade coater, calender or the like may be used to apply the chemicals (e.g., starch, polyvinyl alcohol, dye, coating color, or slide-preventive agent) to paper.

### PREFERRED EMBODIMENTS OF THE INVENTION

Hereinafter, the present invention will be described in more detail by way of Examples which are illustrative only, and should not be construed as limiting the scope of the present invention in any way. Throughout Examples, “parts” and “%” are “parts by weight” and “% by weight”, unless otherwise specified.

The testing methods used are as follows.

Viscosity

The viscosity of a solution was measured with a rotary viscometer while the temperature of a liquid was controlled at 25° C.

Oil Resistance

The oil resistance of paper was measured according to the procedure of TAPPI UM-557. One drop of each of test oils indicated in Table 1 was placed on paper, and the penetration of the oil into the paper was observed 15 seconds later. The maximum of the oil resistance degrees of a test oil which did not penetrate paper was taken as oil resistance.

TABLE 1

| Oil resistance | | | |
|---|---|---|---|
| degree | Castor oil | Toluene | Heptane |
| 1 | 100 | 0 | 0 |
| 2 | 90 | 5 | 5 |
| 3 | 80 | 10 | 10 |
| 4 | 70 | 15 | 15 |
| 5 | 60 | 20 | 20 |
| 6 | 50 | 25 | 25 |
| 7 | 40 | 30 | 30 |
| 8 | 30 | 35 | 35 |
| 9 | 20 | 40 | 40 |
| 10 | 10 | 45 | 45 |
| 11 | 0 | 50 | 50 |
| 12 | 0 | 45 | 55 |

Degree of Size

Degree of size was measured according to the procedure of JIS P-8122.

A piece of paper having a size of 50 mm×50 mm, to be measured, was cut out of a sheet of paper. The paper piece was placed on a level surface, and folded along the lines each about 1 cm inside from the four sides of the paper piece so that the four sides could be directed upward. This folded paper piece was further folded near its four corners so that a paper box opened at the upper side could be shaped by folding along each line which connected each of the four corners to an intersection of the lines which were about 1 cm inside from two sides intersecting near each of the four corners. This paper box was floated on a 2% aqueous ammonium rhodanate solution having a temperature of 20±1° C. put in a Petridish, and simultaneously, one drop of a 1% cupper (II) chloride solution having the same temperature was fallen onto the paper box from a pipet. Then, time (seconds) required until three red spots appeared was measured, and the number of seconds was taken defined as the degree of size.

Resistance to Hot Oil and Resistance to Hot Brine

The resistance to hot oil or hot brine was measured according to the following method based on the inspection items of the China's Rail Ministry. Salad oil heated at 80° C. or brine heated at 80° C. (concentration: 10% by weight) was poured into a pulp-molded container, and was maintained at 80° C. for 30 minutes. Thirty minutes later, the degree of the salad oil or brine oozing from the container was estimated based on the following criteria:

A: No oozing or leaking was observed.

A′: A little oozing was observed.

B: Oozing was observed, but no leaking was observed.

C: Leaking from the container was observed.

### SYNTHESIS EXAMPLE 1

To a reaction vessel having a volume of 500 parts, which was equipped with a stirrer, thermometer, reflux condenser, dropping funnel, nitrogen inlet and heater, were added N-methyl-2-pyrrolidone (NMP) (90 parts), dimethylaminoethyl methacrylate (13 parts), acetic acid (11 parts), N-vinyl-2-pyrrolidone (10 parts), acrylic acid (3 parts), fluorine-containing acrylate (80 parts) of the formula: 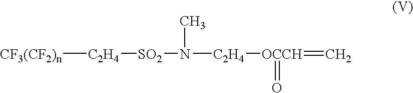
(a mixture of the compounds having the notations n of 5, 7, 9, 11 and 13 in the weight ratio of 1/63/25/9/2), and 4,4′-azobis(4-cyanopentanoic acid) (1 part).

This mixture was heated under a nitrogen atmosphere at 85° C. for 6 hours, and then, an aqueous solution containing water (195 parts) and hydrogen peroxide (35% by weight) (1.4 parts) was added dropwise at 70° C. over 20 minutes. Then, the reaction mixture was cooled to a room temperature. Thus, a transparent and amber-colored solution (S1) (400 parts) was obtained. The concentration of the solid content in this solution was 25%.

### SYNTHESIS EXAMPLE 2

The same operation as in Synthesis Example 1 was repeated, except that dimethylaminoethyl methacrylate (13 parts) used in Synthesis Example 1 was changed to N-tert-butylaminoethyl methacrylate (13 parts). As a result, a transparent and amber-colored solution (S2) (400 parts) was obtained. The concentration of the solid content in this solution was 25%.

### SYNTHESIS EXAMPLE 3

To a reaction vessel having a volume of 500 parts, which was equipped with a stirrer, thermometer, reflux condenser, dropping funnel, nitrogen inlet and heater, were added NMP (90 parts), dimethylaminoethyl methacrylate (15 parts), acetic acid (11 parts), N-vinyl-2-pyrrolidone (6 parts), methacrylic acid (2 parts), fluorine-containing acrylate (80 parts) of the formula: 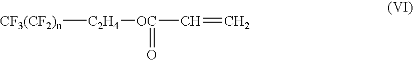
(a mixture of the compounds having the notations n of 7 and 9 in the weight ratio of 85/15), and 4,4′-azobis(4-cyanopentanoic acid) (0.8 parts).

This mixture was heated under a nitrogen atmosphere at 75° C. for 3 hours, and then, 4,4′-azobis(4-cyanopentanoic acid) (0.4 parts) was added to further continue the reaction for 3 hours. Next, an aqueous solution containing water (195 parts) and hydrogen peroxide (35% by weight) (1.4 parts) was added dropwise at 70° C. over 20 minutes. Then, this reaction mixture was cooled to a room temperature. Thus, a transparent and amber-colored solution (S3) (400 parts) was obtained. The concentration of the solid content in this solution was 24.5%.

### SYNTHESIS EXAMPLE 4

The same operation as in Synthesis Example 2 was repeated, except that acrylic acid (3 parts) was changed to sodium styrene sulfonate (1 part). As a result, a transparent and amber-colored solution (S4) (395 parts) was obtained. The concentration of the solid content in this solution was 25.7%.

### SYNTHESIS EXAMPLE 5

To a reaction vessel having a volume of 500 parts, which was equipped with a stirrer, thermometer, reflux condenser, dropping funnel, nitrogen inlet and heater were added NMP (90 parts), quaternary product of dimethylaminoethyl methacrylate (15 parts) of the formula: 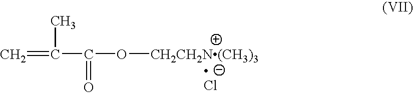
, N-vinyl-2-pyrrolidone (10 parts), methacrylic acid (2 parts), and the same fluorine-containing acrylate (80 parts) as used in Synthesis Example 1 (the mixture of the compounds having the notations n of 5, 7, 9, 11 and 13 in the weight ratio of 1/63/25/9/2).

This mixture was heated under a nitrogen atmosphere of 85° C. for 3 hours, and then, 4,4′-azobis(4-cyanopentanoic acid) (0.4 parts) was added to further continue the reaction for 3 hours. Next, an aqueous solution containing water (145 parts) and acetic acid (12 parts) was added dropwise at 70° C. over 20 minutes. Then, an aqueous solution containing water (50 parts) and hydrogen peroxide (35% by weight) (1.4 parts) was added dropwise at 70° C. over 20 minutes, and the mixture was stirred for 40 minutes. Then, the reaction mixture was cooled to a room temperature. Thus, a transparent and amber-colored solution (S5) (400 parts) was obtained. The concentration of the solid content in this solution was 24.5%.

### SYNTHESIS EXAMPLE 6

To a reaction vessel having a volume of 500 parts, which was equipped with a stirrer, thermometer, reflux condenser, dropping funnel, nitrogen inlet and heater, were added NMP (90 parts), dimethylaminoethyl methacrylate (15 parts), acetic acid (11 parts), N-vinyl-2-pyrrolidone (6 parts), methacrylic acid (2 parts), fluorine-containing acrylate (80 parts) of the formula: 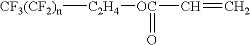
and 4,4′-azobis(4-cyanopentanoic acid) (0.8 parts).

This mixture was heated under a nitrogen atmosphere of 75° C. for 3 hours, and then, 4,4′-azobis(4-cyanopentanoic acid) (0.4 parts) was added to further continue the reaction for 3 hours. Next, an aqueous solution containing water (195 parts) and hydrogen peroxide (35% by weight) (1.4 parts) was added dropwise at 70° C. over 20 minutes. Then, the reaction mixture was cooled to a room temperature. Thus, a transparent and amber-colored solution (S6) (400 parts) was obtained. The concentration of the solid content in this solution was 24.5%.

### COMPARATIVE SYNTHESIS EXAMPLE 1

The same operation as in Synthesis Example 1 was repeated, except that acrylic acid (3 parts) used in Synthesis Example 1 was changed to N-vinyl-2-pyrrolidone (3 parts). The concentration of the solid content in the resultant solution (T1) was 24.0%.

### COMPARATIVE SYNTHESIS EXAMPLE 2

The same operation as in Synthesis Example 3 was repeated, except that methacrylic acid (2 parts) used in Synthesis Example 3 was changed to N-vinyl-2-pyrrolidone (2 parts). The concentration of the solid content in the resultant solution (T2) was 24.0%.

### COMPARATIVE SYNTHESIS EXAMPLE 3

To a reaction vessel having a volume of 1,000 parts, which was equipped with a stirrer, thermometer, reflux condenser, dropping funnel, nitrogen inlet and heater, were added pure water (383 parts), acetone (140 parts), trimethyloleyl ammonium hydrochloride (3.75 parts), polyoxyethylene alkylphenol having HLB of 15 (3.43 parts), methoxyethyl acrylate (43.2 parts), N-methylolacrylamide (12 parts), 75% aqueous solution (12.8 parts) of a monomer of the formula: 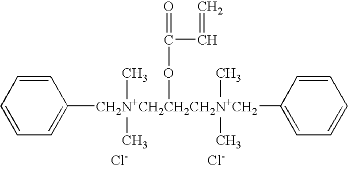
and fluorine-containing acrylate (176.9 parts) of the formula: 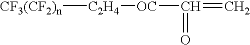
(a mixture of the compounds in which the notations n of 5, 7, 9, 11 and 13 in the average weight ratio of 1/63/24/9/3), and dodecylmercaptan (0.48 parts). This mixture was subjected to nitrogen substitution and heated to 70° C. Then, an aqueous solution of N,N′-azobisamidinopropane hydrochloride (1.2 parts) in water (8 parts) was added to continue the reaction for 2 hours. The reaction mixture was distilled at 90° C. to remove acetone. Thus, an emulsion containing 36% of a solid content was obtained. To this emulsion was added distilled water so as to adjust the solid content to 25%. The resultant solution was referred to the solution (T3).

### COMPARATIVE SYNTHESIS EXAMPLE 4

To a reaction vessel having a volume of 600 parts, which was equipped with a stirrer, thermometer, reflux condenser, dropping funnel, nitrogen inlet and heater, were added methyl isobutyl ketone (40 parts), MEK (2 parts), acetone (27 parts), dimethylaminoethyl methacrylate (16 parts), vinyl acetate (8.8 parts), methacrylic acid (1.2 parts), and fluorine-containing acrylate (81.4 parts) of the formula: 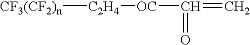
(a mixture of the compounds having the notations n of 5, 7, 9, 11 and 13 in the average weight ratio of 1/63/24/9/3). This mixture was subjected to a nitrogen substitution, and then heated to 70° C. Then, a solution of 4,4′-azobis(4-cyanopentanoic acid) (0.4 parts) in water (8 parts) was added to continue the reaction for 4 hours. Next, an aqueous solution containing water (290 parts), acetic acid (8 parts) and 35% hydrogen peroxide (2.5 parts) was added dropwise at 70° C. over 20 minutes. This mixture was stirred at 70° C. under a stream of nitrogen for 40 minutes. Then, the resulting solution was distilled under reduced pressure to obtain a solution (T4) having a solid content of 25%.

The viscosities of the solutions obtained in Synthesis Examples 1 to 5 and Comparative Synthesis Examples 1 and 2 are shown in Table 2.

TABLE 2

| | Solution | | | | | | |
|---|---|---|---|---|---|---|---|
| | S1 | S2 | S3 | S4 | S5 | T1 | T2 |
| Viscosity (cps) | 650 | 700 | 400 | 250 | 500 | 2,200 | 1,800 |

### EXAMPLE 1

A styrene-acrylic acid copolymer-based sizing agent having a solid content of 1% (AS-233 manufactured by Nippon PMC) (8 g) was added in portions to a 1% aqueous dispersion (1,000 g) of bleached kraft pulp of broad-leaved trees under stirring. The stirring was continued for 2 minutes, and the solution S1 (2.4 g) of Synthesis Example 1, diluted until the solid content reached 1%, was added in portions, and the mixture was stirred for 2 minutes. The resultant pulp slurry was molded into a round tray having a level base, with a pulp-molding machine. The molded tray was dried at 180° C. for 30 minutes. The resultant paper tray had a diameter of 16 cm, a depth of 3 cm and a thickness of 0.6 mm. This paper tray was evaluated in oil resistance and resistance to hot oil and hot brine. The results are shown in Table 3.

### EXAMPLE 2

The operation of Example 1 was repeated in the same manner, except that a polyamide-polyamine-epichlorohydrin reaction product having a solid content of 1% (WS-570 manufactured by Nippon PMC) (4 g) was firstly added in portions to pulp slurry in the step of Example 1, so as to enhance the strength of the resultant paper tray. This paper tray was evaluated in oil resistance and resistance to hot oil and hot brine. The results are shown in Table 3.

### COMPARATIVE EXAMPLE 1

The operation of Example 2 was repeated in the same manner, except that the solution T1 was used instead of the solution S1 of Example 2. The resultant paper tray was evaluated in oil resistance and resistance to hot oil and hot brine. The results are shown in Table 3.

TABLE 3

| | | | Oil resistance | Hot oil | Hot brine |
|---|---|---|---|---|---|
| Ex. No. | Solution | WS-570 | (TAPPI method) | resistance | resistance |
| Ex. 1 | S1 | None | 8 | A | A′ |
| Ex. 2 | S1 | 4 g | 8 | A′ | A′ |
| C. Ex. 1 | T1 | 4 g | 6 | B | A′ |

### EXAMPLES 3 TO 10

The same operation as in Example 1 (using no WS-570) or Example 2 (using WS-570) was repeated to obtain a paper tray in each of Examples 3 to 10, except that the solution, shown in Table 4, having the same solid content, was used. The results of oil resistance and resistance to hot oil and hot brine are shown in Table 4.

### COMPARATIVE EXAMPLES 2 TO 4

The same operation as in Example 2 was repeated in each of Comparative Examples 2 to 4, except that the solution T2 (Comparative Example 2), the solution T3 (Comparative Example 3) or the solution T4 (Comparative Example 4) was used instead of the solution S1 of Example 2. The resultant paper trays were evaluated in oil resistance and resistance to hot oil and hot brine. The results are 5 shown in Table 4.

TABLE 4

| | | | Oil resistance | Hot oil | Hot brine |
|---|---|---|---|---|---|
| Ex. No. | Solution | WS-570 | (TAPPI method) | resistance | resistance |
| Ex. 3 | S2 | None | 8 | A′ | A′ |
| Ex. 4 | S2 | 4 g | 8 | A′ | A′ |
| Ex. 5 | S3 | None | 9 | A | A |
| Ex. 6 | S3 | 4 g | 9 | A | A |
| Ex. 7 | S4 | None | 9 | A | A |
| Ex. 8 | S4 | 4 g | 9 | A | A |
| Ex. 9 | S5 | None | 9 | A | A |
| Ex. l0 | S5 | 4 g | 8 | A | A |
| C. Ex. 2 | T2 | 4 g | 6 | B | A′ |
| C. Ex. 3 | T3 | 4 g | 6 | B | A′ |
| C. Ex. 4 | T4 | 4 g | 6 | B | A′ |

### EXAMPLE 11

The solution S1 (1.2 g) having a solid content of 1%, prepared in Synthesis Example 3, was added in portions to a 1% aqueous dispersion (500 g) of bleached kraft pulp of broad-leaved trees under stirring. The stirring was continued for 2 minutes. The resultant pulp slurry was made into paper with a standard papermaking system described in JIS P8209. The resultant wet paper was sandwiched between filter paper sheets under a pressure of 3.5 kg/cm² so as to sufficiently absorb the moisture of the paper. The paper was dried over a drum drier (100° C.×2 minutes) to obtain oil resistance paper having a basis weight of 80 g/cm².

The oil resistance and the degree of size of this oil resistance paper were evaluated. The results are shown in Table 5.

### EXAMPLE 12

A polyamide-polyamine-epichlorohydrin reaction product (WS-570 manufactured by Nippon PMC) (2 g) having a solid content of 1% was added in portions to a 1% aqueous dispersion (500 g) of bleached kraft pulp of broad-leaved trees under stirring. The stirring was continued for 2 minutes. Then, the solution S1 having a solid content of 1% (1.2 g), prepared in Synthesis Example 3, was added in portions, and the mixture was stirred for 2 minutes. The resultant pulp slurry was made into paper with a standard papermaking system described in JIS P8209. The resultant wet paper was sandwiched between filter paper sheets under a pressure of 3.5 kg/cm² so as to sufficiently absorb the moisture of the paper. The paper was dried over a drum drier (100° C.×2 minutes) to obtain oil-resistant paper having a basis weight of 80 g/cm². The oil resistance and the degree of size of this oil-resistant paper were evaluated. The results are shown in Table 5.

### EXAMPLE 13

The operation of Example 11 was repeated, except that the solution S6 prepared in Synthesis Example 6 was used instead of the solution S1 of Example 11. The oil resistance and the degree of size of the resultant paper were evaluated. The results are shown in Table 5.

### EXAMPLE 14

The operation of Example 12 was repeated, except that the solution S6 prepared in Synthesis Example 6 was used instead of the solution S1 of Example 12. The oil resistance and the degree of size of the resultant paper were evaluated. The results are shown in Table 5.

### COMPARATIVE EXAMPLE 5

The operation of Example 11 was repeated, except that the solution T2 was used instead of the solution S1 of Example 11. The oil resistance and the degree of size of the resultant paper were evaluated. The results are shown in Table 5.

### COMPARATIVE EXAMPLE 6

The operation of Example 12 was repeated, except that the solution T2 was used instead of the solution S1 of Example 12. The oil resistance and the degree of size of the resultant paper were evaluated. The results are shown in Table 5.

### COMPARATIVE EXAMPLE 7

The operation of Example 11 was repeated, except that the solution T3 was used instead of the solution S1 of Example 11. The oil resistance and the degree of size of the resultant paper were evaluated. The results are shown in Table 5.

### COMPARATIVE EXAMPLE 8

The operation of Example 12 was repeated, except that the solution T3 was used instead of the solution S1 of Example 12. The oil resistance and the degree of size of the resultant paper were evaluated. The results are shown in Table 5.

### COMPARATIVE EXAMPLE 9

The operation of Example 11 was repeated, except that the solution T4 was used instead of the solution S1 of Example 11. The oil resistance and the degree of size of 10 the resultant paper were evaluated. The results are shown in Table 5.

### COMPARATIVE EXAMPLE 10

The operation of Example 12 was repeated, except that 15 the solution T4 was used instead of the solution S1 of Example 12. The oil resistance and the degree of size of the resultant paper were evaluated. The results are shown in Table 5.

TABLE 5

| | | | Oil resistance | Degree of |
|---|---|---|---|---|
| Ex. No. | Solution | WS-570 | (TAPPI method) | size (sec.) |
| Ex. 11 | S1 | None | 8 | 18 |
| Ex. 12 | S1 | 4 g | 8 | 16 |
| Ex. 13 | S6 | None | 8 | 22 |
| Ex. 14 | S6 | 4 g | 8 | 18 |
| C. Ex. 5 | T2 | None | 8 | 16 |
| C. Ex. 6 | T2 | 4 g | 5 | 6 |
| C. Ex. 7 | T3 | None | 7 | 18 |
| C. Ex. 8 | T3 | 4 g | 5 | 18 |
| C. Ex. 9 | T4 | None | 8 | 18 |
| C. Ex. 10 | T4 | 4 g | 5 | 18 |

### EFFECT OF THE INVENTION

The treatment agents of the present invention impart sufficient water resistance and oil resistance to paper, even when sizing agents and paper strength-enhancing agents are present.

1. A fluorine-containing copolymer comprising
(a) 50 to 92% by weight of at least one fluoromonomer of the general formula: 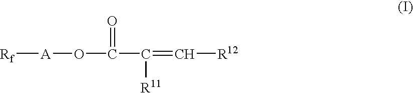
wherein R_{f} represents a linear or branched fluoroalkyl group having 1 to 21 carbon atoms, preferably 4 to 16 carbon atoms,
A represents a divalent organic group having a carbon atom to be bonded to an oxygen atom adjacent to the group A, and if needed, at least one oxygen atom, sulfur atom and/or nitrogen atom, one of R¹¹ and R¹² represents a hydrogen atom, and the other thereof represents a hydrogen atom or an alkyl group having 1 to 4 carbon atoms;
(b) 1 to 25% by weight of at least one nitrogen-containing 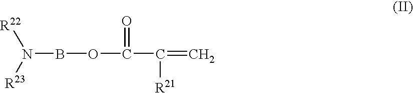
monomer of the general formula: and/or 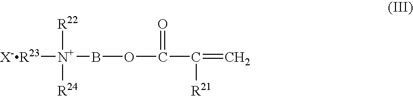
wherein B represents a linear or branched alkylene group having 1 to 4 carbon atoms,
R²¹ represents a hydrogen atom or an alkyl group having 1 to 4 carbon atoms,
R²², R²³ and R²⁴ are the same of different, each representing a hydrogen atom, a linear or branched alkyl group having 1 to 18 carbon atoms, or a hydroxyethyl group or a benzyl group; or otherwise, R²² and R²³ together form a divalent organic group having 2 to 30 carbon atoms, and
X⁻ represents an anionic group;
(c) 1 to 25% by weight of a pyrrolidone monomer of the general formula: 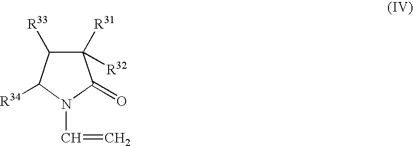
wherein R³¹, R³², R³³ and R³⁴ are the same or different, each representing a hydrogen atom or an alkyl group having 1 to 4 carbon atoms; and
(d) 1 to 5% by weight of a monomer having an anionic functional group.

2. A copolymer according to claim 1, further comprising
(e) 0 to 10% by weight of a monomer other than the monomers (a), (b), (c) and (d).

3. A copolymer according to claim 1, wherein said fluoromonomer (a) is at least one fluoromonomer of the formula (I) in which R_{f} represents a perfluoroalkyl group having 4 to 16 carbon atoms.

4. A copolymer according to claim 1, wherein said nitrogen-containing monomer (b) is dimethylaminoethyl methacrylate, dimethylaminopropyl methacrylate, diethylaminoethyl methacrylate, diethylaminopropyl methacrylate, N-tert.-butylaminoethyl methacrylate, dimethylaminoethyl acrylate, dimethylaminopropyl acrylate, diethylaminoethyl acrylate, diethylaminopropyl acrylate, N-tert.-butylaminoethyl acrylate, or a mixture thereof.

5. A copolymer according to claim 1, wherein said pyrrolidone monomer (c) is N-vinyl-2-pyrrolidone, N-vinyl-3-methyl-2-pyrrolidone, N-vinyl-4-methyl-2-pyrrolidone, N-vinyl-5-methyl-2-pyrrolidone, N-vinyl-3,3-dimethyl-2-pyrrolidone, or a mixture thereof.

6. A copolymer according to claim 1, wherein said anionic functional group-containing monomer (d) is acrylic acid, methacrylic acid, sodium styrene sulfonate, itaconic acid, fumaric acid, or a mixture thereof.

7. A copolymer according to claim 1, wherein said fluoromonomer (a) is at least one fluoromonomer of the formula (I) in which R_{f} represents a perfluoroalkyl group having 4 to 16 carbon atoms; said nitrogen-containing monomer (b) is dimethylaminoethyl methacrylate; said pyrrolidone monomer (c) is N-vinylpyrrolidone; and said anionic functional group-containing monomer (d) is methacrylic acid.

8. A copolymer according to claim 1, wherein said fluoromonomer (a) is a compound of the formula: F(CF₂)₈CH₂CH₂OCOCH═CH₂ or F(CF₂)₁₀CH₂CH₂OCOCH═CH₂, or a mixture thereof; said nitrogen-containing monomer (b) is dimethylaminoethyl methacrylate; said pyrrolidone monomer (c) is N-vinylpyrrolidone; and said anionic functional group-containing monomer (d) is methacrylic acid.

9. A copolymer according to claim 1, wherein said fluoromonomer (a) is a mixture of a compound of the formula: F(CF₂)₈CH₂CH₂OCOCH═CH₂ and a compound of the formula: F(CF₂)₁₀CH₂CH₂OCOCH═CH₂; said nitrogen-containing monomer (b) is dimethylaminoethyl methacrylate; said pyrrolidone monomer (c) is N-vinylpyrrolidone; and said anionic functional group-containing monomer (d) is methacrylic acid, and wherein the weight ratio of these monomers is 66:14:15:3:2.

10. A method for using a copolymer according to claim 1, for treating a solid substrate, particularly paper and cardboard to impart lipophobic property and hydrophobic property thereto.

11. A paper treatment agent comprising a copolymer according to claim 1.

12. A paper treatment agent according to claim 11, which is applied to the surface of paper in such an amount that the ratio of the weight of fluorine atoms in the agent to the weight of the paper can be 0.05 to 0.2% by weight.

13. A paper treatment agent according to claim 11, which is applied to a whole of paper including the internal layer thereof, in such an amount that the ratio of fluorine atoms in the agent to the weight of pulp can be 0.2 to 0.4% by weight.

14. Processed paper treated with a paper treatment agent according to claim 11.

15. A process for preparing a copolymer according to claim 1, comprising the steps of copolymerizing the monomers (a), (b), (c) and (d) in a water-soluble organic solvent or a solution of a mixture of water-soluble organic solvents, and if needed, diluting the copolymer with an aqueous solution of an inorganic or organic acid.

16. A process for preparing a copolymer according to claim 1, comprising the steps of previously neutralizing the nitrogen-containing monomer with an acid, and polymerizing the monomers.

17. A process according to claim 15, wherein the copolymer is treated with an aqueous solution of hydrogen peroxide after the polymerization.

18. A process according to claim 15, wherein the amount of hydrogen peroxide is 0.1 to 10%, preferably 0.3 to 3% based on the total weight of the monomers.

19. A process according to claim 15, wherein the solvent for use in the copolymerization is N-methyl-2-pyrrolidone.

20. A process according to claim 15, wherein the solvent for use in the copolymerization is acetone, acetonitrile, methanol, or a mixture thereof.

21. A process according to claim 15, wherein the acid in the aqueous organic acid solution is acetic acid.

22. A process for preparing a copolymer according to claim 1, comprising the steps of copolymerizing the monomers (a), (b), (c) and (d) in acetone, acetonitrile, methanol, or a mixture thereof, and if needed, diluting the copolymer with an aqueous solution of an inorganic or organic acid, and then distilling off the organic solvent.
